(19) United States
(12) Patent Application Publication
(10) Pub. No.: US 2007/0061500 A1
(43) Pub. Date: Mar. 15, 2007

(54) Relocatable overlay window to access supernumerary data resources

(75) Inventors: Geoffrey Gould, El Dorado Hills, CA (US); Steven Peterson, Sacramento, CA (US); Mark Leinwander, Folsom, CA (US)

Correspondence Address: LEE & HAYES, PLLC;c/o PORTFOLIOIP, P.O. BOX 52050, MINNEAPOLIS, MN, 55402, US

(73) Assignee: Intel Corporation

(21) Appl. No.: 11/223,399

(22) Filed: Sep. 9, 2005

(51) Int. Cl. G06F 12/00

(52) U.S. Cl. 711/103; 711/154; 711/202

(57) ABSTRACT

Described herein are one or more implementations that eliminate the need to switch data-resource access-modes of a flash memory system between a primary main array memory and a secondary supernumerary data resource. The one or more described implementations provide access to the secondary supernumerary data resource through an overlay window in the addressable memory space of primary main array memory. Memory accesses (e.g., reads or writes) which specify a memory location which is within the defined address space of the overlay window are redirected to the secondary supernumerary data resource instead of accessing the primary main array memory.

### BACKGROUND

“Flash memory” is an example of one kind of solid-state electronic memory. Flash memory is highly reliable, shock-and-vibration resistant, low-power-consuming, non-volatile memory which utilizes a relatively low-cost, high-density, high-speed architecture. Flash memory does not need a constant power supply to retain its data and it offers extremely fast access times. These qualities combined with its compact size, make flash memory desirable for scanners, printers, video game consoles, digital cameras, mobile phones, pagers, handheld computers, and other portable devices.

FIG. 1 illustrates a typical portable computing device 100 which might utilize flash memory. Some of the relevant components of the device are represented within box 110. These depicted components include at least one processing core 120 (which includes essential processing components and related memory systems), a communications bus 122, an interrupt queue 124, and a flash memory system 130. The processing core 120 communicates with the interrupt queue 124, the flash memory system 130, and other unspecified components (not shown) via the bus 122.

As is typical for conventional flash memory devices, the flash memory system 130 of FIG. 1 includes two separate data storage areas from which the processing core 120 may access (e.g., read or write) data. The primary data storage area is a main array memory 132, which is the primary working storage space used by the customer/end-user/programmer/developer to store executable program modules, data, and the like. The main array memory 132 may be used to store, for example, text files, images, digital music, database data, digital video, operating system components, applications, device drivers, and the like. The main array memory 132 may include as much memory as the full breadth of memory which the processing core is capable of addressing. For example, in a 32-bit memory address scheme, the main array memory 132 may include the full four gigabytes of addressable memory, or may include a subset of the four gigabytes.

The secondary data storage area are supernumerary data resources 134. Generally, “supernumerary” means exceeding a fixed, prescribed, or standard number or amount. Herein, the supernumerary data resources are specifically those resources that are typically accessed outside the full range of addressable memory available to the primary main array memory 132. Herein, the supernumerary data resources 134 expressly include memory and non-memory data resources. Non-memory supernumerary data resources 134 include input/output sources and data generation sources. Memory supernumerary data resources 134 expressly includes array and non-array memory.

The access-mode switch logic 136 determines whether an incoming memory-access request will retrieve data from the primary main array memory 132 or the secondary supernumerary memory 134. When a flash memory device is in a main array “access-mode,” it responds to a memory access with the content located at a designated memory location in the primary main array memory 132. When the flash memory is in the secondary access-mode, it responds with data content found in the secondary supernumerary memory 134.

Typically, the processing core 120 is mode-agnostic. When the processing core submits an access request, the core is not aware of “access-modes.” Instead, one or more higher level components (e.g., a BIOS device driver or operating system) selects the access-mode of the flash memory system 130. If this higher-level component and the flash memory system gets “out of synch,” then it is possible for the processing core to retrieve data from the secondary supernumerary memory 134 when it expects to retrieve data from the main array memory 132 and vice versa.

In conventional approaches, strategies were implemented to reduce the chances of the flash memory being in an unexpected mode. Interrupts demand immediate action by the mode-agnostic processing core 120 and may cause it to access memory without a needed change of access-mode. Therefore, one conventional approach is to mask incoming interrupts and place them in the interrupt queue 124.

Consequently, interrupts are not immediately recognized and serviced. Instead, mode-aware higher-level components periodically examine the interrupt queue 124. These mode-aware higher-level components release pending interrupts and, if necessary, switch the access-mode of the flash memory before releasing pending interrupts.

### BRIEF DESCRIPTION OF THE DRAWINGS

The same numbers are used throughout the drawings to reference like elements and features.

FIG. 1 illustrates a typical device which utilizes a flash memory system.

FIG. 2 illustrates an exemplary device and its flash memory system in accordance with one or more implementations described herein.

FIG. 3 illustrates the re-locatability of the supernumerary overlay window in accordance with one or more implementations described herein.

FIG. 4 illustrates another exemplary embodiment in accordance with one or more implementations described herein.

FIG. 5 illustrates a flow diagram showing a methodological implementation described herein.

### DETAILED DESCRIPTION

Rather than switching access-modes of a flash memory system between a primary main array memory and a secondary supernumerary data resource, one or more implementations, described herein, provides access to the secondary supernumerary data resource through an overlay window in the primary main array memory. One or more of the described implementations sacrifice a relatively tiny defined address space of the primary main array to act as this overlay window. Access to a memory location within this overlay window are redirected to the secondary supernumerary data resource.

Since the sacrificed address space of the primary main array memory is inaccessible when the overlay window is active, the overlay window is re-locatable. With knowledge of the high-level organizational structure of the data in the primary main array memory, one or more of the described implementations select a present location of the overlay window which is unlikely to be accessed given a present status of the high-level systems (e.g., operating system) of the computing device utilizing the flash memory system.

One or more of the described implementations simplifies system software integration and reduces interrupt latency by keeping the vast majority of contents of the main-array memory accessible at all times.

When compared to the traditional approach that switches access-modes to access the two separated data resources (e.g., main array memory and secondary supernumerary data resources), the new approach provided by one or more implementations described herein simplifies system software integration by eliminating or ameliorating the need to:
request and receive operating system (OS) semaphores;
mask interrupts;
lock some software routines in instruction cache (“i-cache”) or download into RAM shadow;
poll for interrupts while executing software that would otherwise disable a very large portion of the Flash main-array when that Flash chip is accessing non-array data.
service any interrupts manually while interrupts are masked;
unlock i-cache or release memory allocation of the RAM shadow;
unmask interrupts; and/or
release OS semaphore.
   One or More Exemplary Embodiments

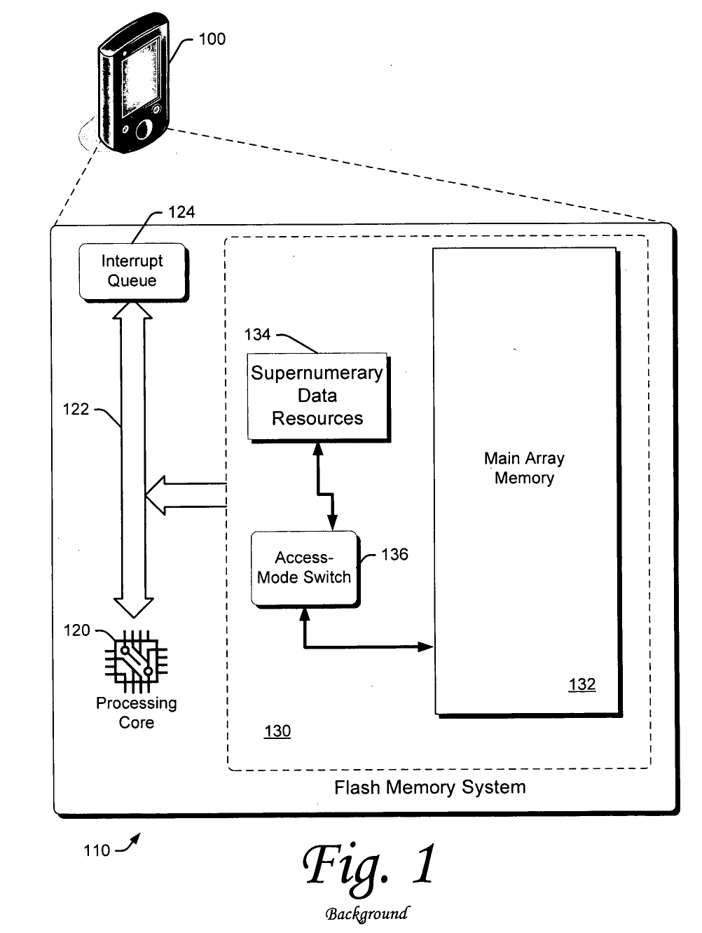

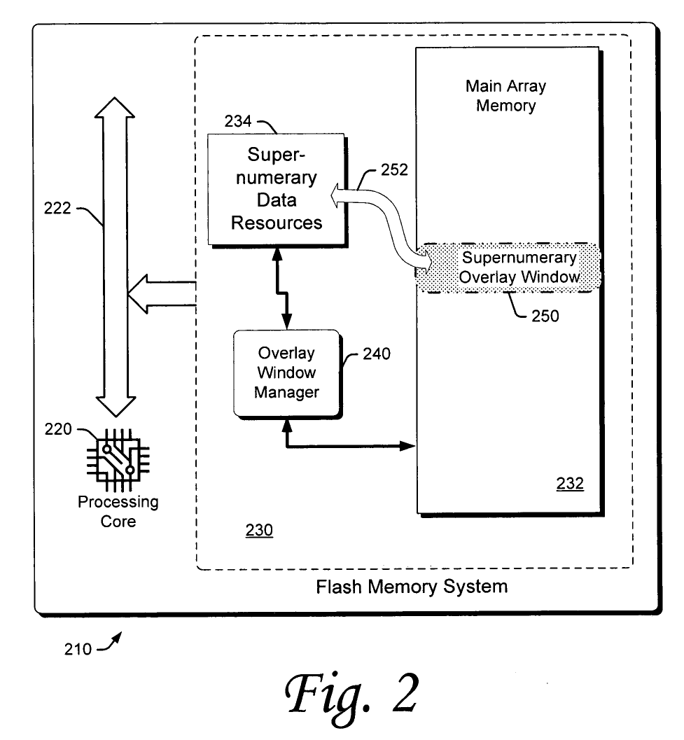

FIG. 2 illustrates components of a flash-memory-employing device that is suitable for one or more implementations described herein. For ease of understanding, the last two digits of the reference indicators for nominally matching components correspond between the traditional flash-memory device 100 shown in FIG. 1 and new device shown in FIG. 2.

Box 210 includes some of the relevant components of one or more implementations. These depicted components include at least one processing core 220 which includes essential processing components (e.g., one or more processors) and related memory systems), a communications bus 222, and a flash memory system 230. The processing core 220 communicates with the flash memory system 230, and other unspecified components (not shown) via the bus 222. Since an interrupt queue is unnecessary in one or more implementations described herein, there is no interrupt queue depicted in FIG. 2.

The flash memory system 230 of FIG. 2 includes two separate data resource areas from which the processing core 220 may access (e.g., read or write) data. The primary data storage area is a primary main array memory 232. The secondary data storage area is supernumerary data resources 234. Herein, references to a “supernumerary data resources” refer to the secondary data resources of a system which are not used as the working space by the customer/end-user/programmer/developer to store executable program modules, data, and the like.

The supernumerary data resources 234 are typically those that accessed outside the full range of addressable memory available to the primary main array memory 232. Herein, the supernumerary data resources 234 expressly include memory and non-memory data resources. Non-memory supernumerary data resources 234 include input/output sources and data generation sources, such as dynamic output of arithmetic circuits and noise-based pseudorandom number generators. Memory supernumerary data resources 234 expressly includes array and non-array memory. For example, the memory supernumerary data resources 234 may include secondary arrays of Flash memory and/or SRAM memory.

In one or more implementations described herein, the supernumerary data resources 234 is a non-array memory, which includes, for example, memory-mapped registers, SRAM buffers, flip-flops, or any other memory technology.

Typically, much of the data in non-array memory is pre-programmed or pre-set by the manufacturer of the flash memory device. By way of example only and not limitation, the data in a non-array memory contains identifier codes, common-flash-interface (CFI) datasheet-in-a-chip, one-time-programmable (OTP) serial codes. Other non-array memory contents typically are dynamic during system operation. By way of example only and not limitation, the data in an array memory contains read configuration registers, status registers, block lock flags, programming buffers, and read buffers. The storage capacity of the non-array memory is typically one or more orders of magnitude smaller than the storage capacity of a main array memory.

With the one or more implementations, the flash memory system 230 no longer needs access-mode switch logic like that depicted at 136 in FIG. 1. Rather than switching access-modes between the primary main array memory 232 and the secondary supernumerary data resource 234, an overlay window manager 240 provides access to the secondary supernumerary data resource 234 through a supernumerary overlay window 250 in the primary main array memory 232. The overlay window manager 240 may be implemented by hardware only, by software only, or by a combination of both.

The overlay window manager 240 defines an address space in the primary main array memory 232 to act as this supernumerary overlay window 250. Therefore, when the processing core 220 attempts to access a memory address within that defined address space in the primary main array memory, that access is redirected to the secondary supernumerary data resource 234 instead. This redirection is illustrated by double-headed arrow 252 in FIG. 2.

Because of this redirection, the flash memory system 230 never needs to change modes like the traditional approach illustrated in FIG. 1 in order to read or write data from the secondary supernumerary data resource 234 in the midst of several reads/writes to the primary main array memory 232 or vice versa.

However, the overlay window manager 240 sacrifices an otherwise addressable memory space in the primary main array memory 232 when it defines the supernumerary overlay window 250 to exist over that addressable memory space. The data in that sacrificed address space of the primary main array memory 232 is inaccessible when the supernumerary overlay window 250 is active.

To expose the “hidden” data behind the supernumerary overlay window 250, the window is re-locatable within the primary main array memory 232. With knowledge of the high-level organizational structure of the data in the primary main array memory 232, the overlay window manager 240 (and/or one or more higher-level components such as a BIOS driver or operating system) select a new location for the overlay window making inaccessible a region of the primary main array memory which is unlikely to be accessed given a present status of the high-level system (e.g., operating system) of the computing device utilizing the flash memory system 230.

Typically, the data in the primary main array memory 232 is logically divided into multiple segments of contiguous memory. For example, there may be one segment for loading an operating system, another segment for low-level operating system software (i.e., kernel), another segment for data, and perhaps another segment for executable instructions. It is also common for a computing device employing a flash memory system to operate in multiple states, phases, or cycles. For example, the phases may include the initial power-up, the loading of initial system software, normal operation, etc. Typically, it is common for the frequency of memory access for each segment to vary relative to the present operating phase of the computer device.

While the above embodiments focus on the present operating phase of the computer device as a trigger for relocation of the supernumerary overlay window, there may be other factors that could cause a relocation trigger. By way of example only (and not limitation) the following are other exemplary independent triggers:
User request for low-power mode (sometimes called “standby” or “hibernate”).
User request to power down and turn off the device.
Installation of dynamic linked library (DLL).
Activation of installable kernel module.
Activation of application code, including Java™ virtual machine.
Changing language fonts, either in response to user request or due to automatic location-aware feature.
Changing graphic-user-interface (GUI) styles.
Accessing a file system which stores data in the memory device 230.
   Of course, the triggering event may be the result of a combination of more than one trigger.

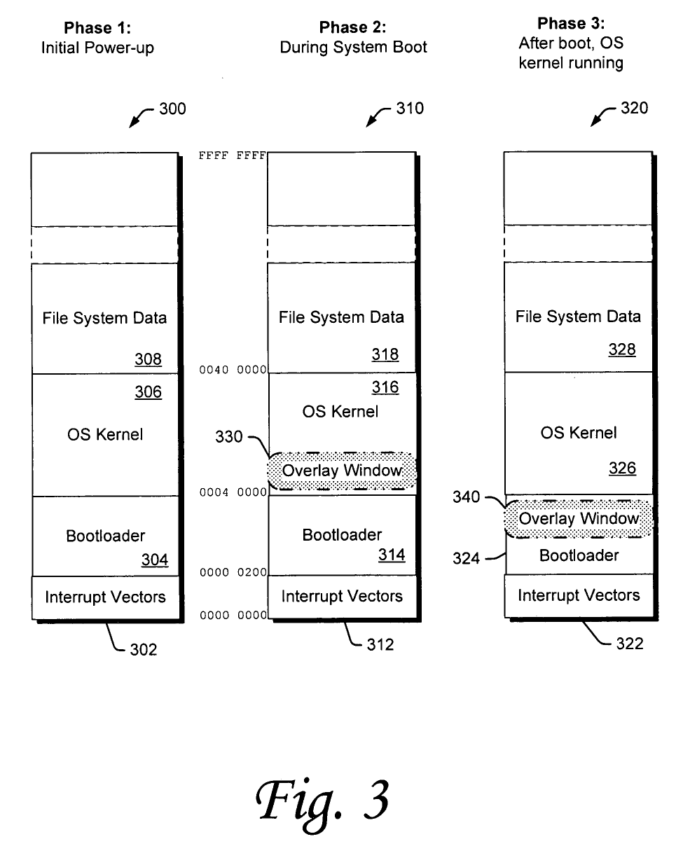

FIG. 3 illustrates one relocation scenario that utilizes three phases, which are depicted by representations 300, 310, and 320 of the primary main array memory. Each representation illustrates the primary main array memory 232 logically divided into multiple segments of contiguous memory: interrupt vectors segment, bootloader segment, operating system (OS) kernel segment, and file system data (for storing executable instructions and/or data) segment.

Phase-1 representation 300 depicts the initial power-up of the device. In this representation, the memory is logically divided into interrupt vectors segment 302, bootloader segment 304, OS kernel segment 306, and file system data segment 308. In Phase-1, there is no need yet for an overlay window; so, none is shown in the phase-1 representation 300.

Phase-2 representation 310 depicts the system boot cycle of the device. In this representation, the memory is logically divided into interrupt vectors segment 312, bootloader segment 314, OS kernel segment 316, and file system data segment 318. During this phase, the processing core 220 will not yet be accessing data in the OS kernel segment 316. Therefore, the overlay window manager 240 places a supernumerary overlay window 330 in the OS kernel segment 316.

Phase-3 representation 320 depicts normal operating state of the device. This is after booting and the OS kernel is now operating. In this representation, the memory is logically divided into interrupt vectors segment 322, bootloader segment 324, OS kernel segment 326, and file system data segment 328. During this phase, the processing core will no longer be accessing data in the bootloader segment 324 because the device has already completed the boot process. Therefore, the overlay window manager 240 places a supernumerary overlay window 340 in the bootloader segment 324.

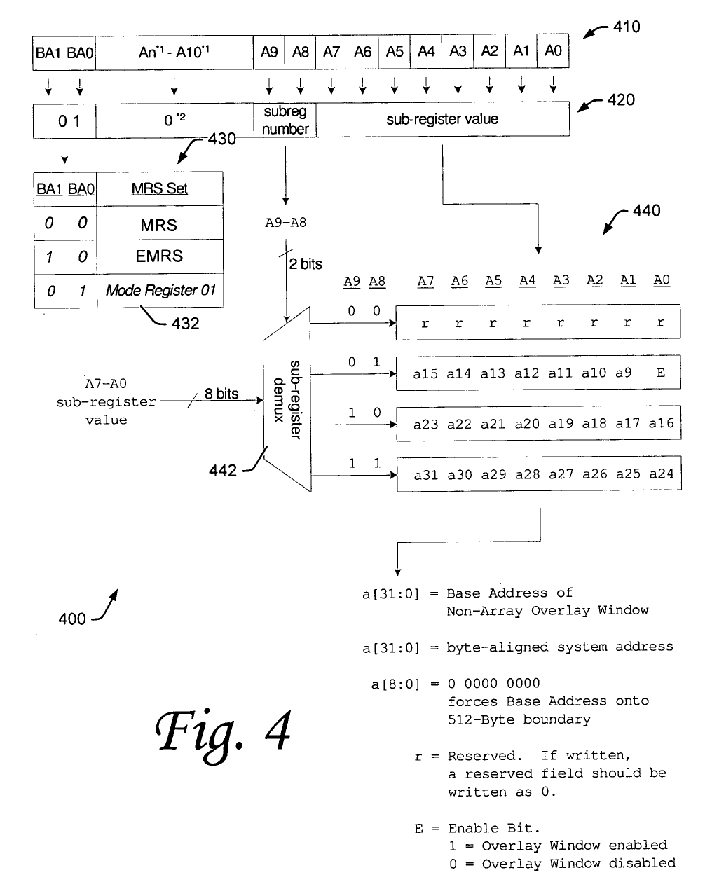

FIG. 4 illustrates an alternative embodiment of the overlay window manager 240. This embodiment utilizes an existing hardware with a known memory addressing scheme which is familiar to those who are skilled in the art. This known addressing memory is similar to what is used in typical SDRAM memories (especially low-power double-data-rate (LPDDR) or other double-data-rate (DDR) memories). In particular, this embodiment utilizes the customizable nature of the “mode” registers of such a scheme to implement one of the new features of this embodiment. More particularly, the customized “mode” registers are used to define a starting location of the defined address space for the supernumerary overlay window.

As shown in FIG. 4, block 410 represents a memory address used to load a configuration value into a mode register. Block 410 also labels individual bits in that address (e.g., AO, Al, etc.). In an alternative embodiment, data bits could be used to load a configuration value into a mode register. Block 420 corresponds to block 410 and it labels collections of bits in a memory address (e.g., bits A8-A9 are the “subreg number”). Chart 430 indicates the meaning of the mode-registers (MRS) bits (i.e., BAl and BAO) in a memory address. The MRS setting (“00”) and the extended mode-register (EMRS) setting (“10”) were already predefined in the existing memory addressing scheme. However, a “mode register 01” setting 432 is a customized setting to achieve the described embodiment.

Register 440 represents a mode register. A sub-register demux 442 determines which sub-register is being accessed within the mode register. When the MRS bits are set to “01,” then data being written to or read from the register 440 is the “mode register 01.” More particularly, the value being written to or read from the register 440 in these instances is the starting location of the defined address space for the overlay window.

Methodological Implementation

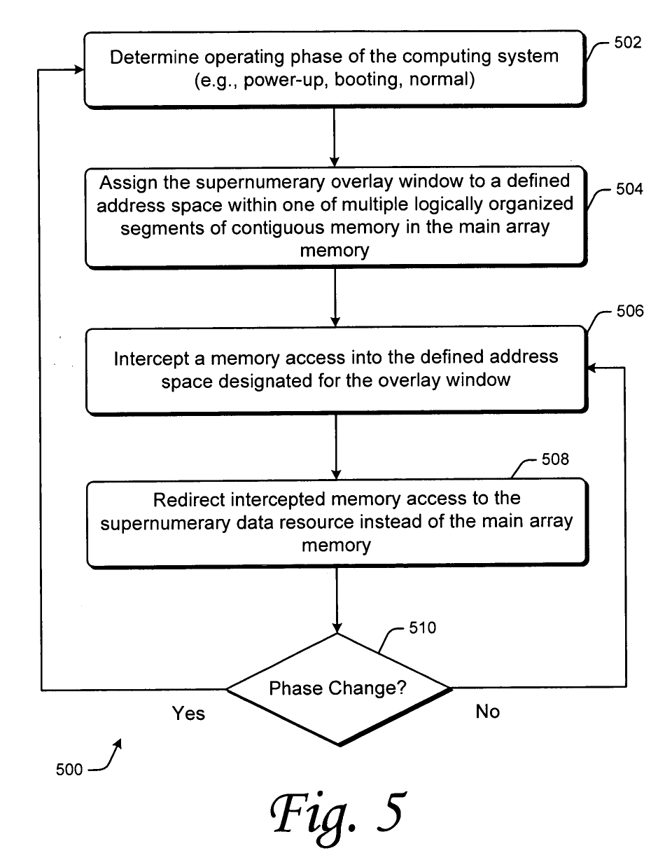

FIG. 5 shows method 500 for managing a re-locatable supernumerary overlay window. This method 500 is performed by the one or more of the various components as depicted in FIG. 2. Furthermore, this method 500 may be performed in software, hardware, firmware, or a combination thereof. For ease of understanding, this method is delineated as separate steps represented as independent blocks in FIG. 5; however, these separately delineated steps should not be construed as necessarily order dependent in their performance. Additionally, for discussion purposes, the method 500 is described with reference to FIGS. 2 and 3. Also for discussion purposes, particular components are indicated as performing particular functions; however, other components (or combinations of components) may perform the particular functions.

At 502 of FIG. 5, the overlay window manager 240 (or some other component of a device implementing a flash memory system like system 230—which includes a software component) determines the present operating phase of the host computing system. Examples of operating phases include initial power-up, bootloading, and normal operations. Of course, these are just examples of phases and a system may have many other phases and many different types of operational phases.

At 504, the manager 240 assigns the location (e.g., a defined address space) of the supernumerary overlay window (such as window 250) within one of multiple logically organized segments of contiguous memory in the main array memory. For example, as shown in FIG. 3, the supernumerary overlay window 330 may be located within the OS kernel 316 memory segment of the Phase-2 representation 310 of the main array memory. The exact location where the overlay window is defined may be calculated, pre-determined (e.g., from a table), or simply supplied by a higher-level component (such as BIOS driver or operating system).

However, depending upon the phase, it may be desirable to leave a supernumerary overlay window unassigned and undefined. This may be desirable when there is no need to access the data found in the non-array memory. This situation is illustrated by the Phase-1 representation 300 of FIG. 3. In this instance, no overlay window is assigned to any segment of the main array memory.

At 506, the manager 240 intercepts any incoming memory access (e.g., read or write) into the defined address space designated for the supernumerary overlay window. Therefore, such memory access will not gain access to the content in the main array memory that is “hidden” behind the overlay window.

At 508, the manager 240 redirects the intercepted access to the secondary supernumerary data resources instead of the main array memory. Therefore, this intercepted access will read/write data from/to the secondary supernumerary data resources rather than the main array memory. Furthermore, it does this without requiring the flash memory hardware to change “access-modes.”

At 510, the manager 240 (or some other component of a device implementing a flash memory system like system 230—which includes a software component) determines if there has been a change in the operational phase. If so, then the entire process repeats by going back to block 502 to determine the current operating phase. If not, then the process maintains a loop back to block 506 to continuously check for incoming memory accesses into the overlay window.

The above discusses changes in operational phases as being the trigger to relocate the supernumerary overlay window. However, this is just one or many possible implementations. Those of skill in the art understand that other behaviors, actions, or conditions may trigger a relocation of the overlay window. In general, a relocation trigger may occur when a change in conditions occurs so that another memory segment (other than the one that the window currently resides) becomes the least likely segment to be accessed.

Conclusion

The techniques, described herein, may be implemented in many ways, including (but not limited to) program modules, general- and special-purpose computing systems, network servers and equipment, dedicated electronics and hardware, and as part of one or more computer networks.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A device comprising:
a primary main array memory having a full range of addressable memory locations;
a secondary supernumerary data resource, wherein the secondary supernumerary data resource is not within the full range of addressable memory locations of the primary main array memory;
a supernumerary overlay window manager configured to:
intercept an incoming memory access specifying an address of a memory location within a defined address space designated for a supernumerary overlay window;
redirect the incoming memory access into the designated supernumerary overlay window to the secondary supernumerary data resource.

2. A device as recited in claim 1, wherein the non-array window manager is further configured to relocate the supernumerary overlay window by redefining a new address space in the primary main array memory for the supernumerary overlay window.

3. A device as recited in claim 1, wherein the primary main array memory is logically divided into multiple segments of contiguous memory locations and the supernumerary overlay window manager being further configured to relocate the supernumerary overlay window by redefining another address space for the supernumerary overlay window, the redefined address space being located entirely within one of the multiple segments.

4. A device as recited in claim 1, wherein the non-array window manager is further configured to relocate the supernumerary overlay window by redefining another address space in the primary main array memory and to perform the relocation in response to a predefined trigger.

5. A device as recited in claim 1, wherein the primary main array memory is logically divided into multiple segments of contiguous memory locations and the supernumerary overlay window manager being further configured to define an address space for the supernumerary overlay window entirely within one of the multiple segments.

6. A device as recited in claim 1, wherein the supernumerary overlay window manager employs a mode register of a memory system to define a starting memory address of the address space for the supernumerary overlay window.

7. A device as recited in claim 1, wherein device comprises a flash memory system.

8. A device as recited in claim 1, wherein the secondary supernumerary data resource comprises non-array memory.

9. A device comprising:
a primary main array memory having a full range of addressable memory locations;
a secondary supernumerary data resource, wherein the secondary supernumerary data resource is not within the full range of addressable memory locations of the primary main array memory;
a supernumerary overlay window manager configured to:
define an address space in the primary main array memory as a supernumerary overlay window;
intercept an incoming memory access specifying an address of a memory location within the defined address space designated for the supernumerary overlay window;
redirect the incoming memory access to the secondary supernumerary data resource.

10. A device as recited in claim 9, wherein the non-array window manager is further configured to relocate the supernumerary overlay window by redefining another address space in the primary main array memory.

11. A device as recited in claim 9, wherein the non-array window manager is further configured to relocate the supernumerary overlay window by redefining another address space in the primary main array memory and to perform the relocation in response to a predefined trigger.

12. A device as recited in claim 9, wherein the non-array window manager is further configured to relocate the supernumerary overlay window by redefining another address space in the primary main array memory and to perform the relocation in response to a change in operating conditions of the device.

13. A device as recited in claim 9, wherein the primary main array memory is logically divided into multiple segments of contiguous memory locations and the supernumerary overlay window manager being further configured to define an address space for the supernumerary overlay window entirely within one of the multiple segments.

14. A device as recited in claim 9, wherein the primary main array memory is logically divided into multiple segments of contiguous memory locations and the supernumerary overlay window manager being further configured to relocate the supernumerary overlay window by redefining another address space which is located entirely within one of the multiple segments.

15. A device as recited in claim 9, wherein the primary main array memory is logically divided into multiple segments of contiguous memory locations and the supernumerary overlay window manager being further configured to relocate the supernumerary overlay window by redefining another address space which is located entirely within one of the multiple segments and to perform the relocation in response to a predefined trigger.

16. A device as recited in claim 9, wherein the supernumerary overlay window manager employs a mode register of a memory system to define a starting memory address of the address space for the supernumerary overlay window.

17. A device as recited in claim 9, wherein device comprises a flash memory system.

18. A device as recited in claim 9, wherein the secondary supernumerary data resource comprises non-array memory.

19. A method comprising:
defining an address space in a primary main array memory as a supernumerary overlay window, the primary main array memory having a full range of addressable memory locations;
intercepting an incoming memory access specifying an address of a memory location within the defined address space designated for the supernumerary overlay window;
redirecting the incoming memory access to a secondary supernumerary data resource, wherein the secondary supernumerary data resource is not within the full range of addressable memory locations of the primary main array memory.

20. A method as recited in claim 19 further comprising relocating the supernumerary overlay window by redefining another address space in the primary main array memory.

21. A method as recited in claim 19, wherein the primary main array memory is logically divided into multiple segments of contiguous memory locations, the method further comprising relocating the supernumerary overlay window by redefining another address space which is located entirely within one of the multiple segments.

22. A method as recited in claim 19, wherein the defining is characterized by storing a starting memory address of the defined address space for the supernumerary overlay window into a mode register of a memory system.

23. A method as recited in claim 19, wherein the secondary supernumerary data resource comprises non-array memory.

24. One or more computer-readable media having computer-executable instructions that, when executed on a computing device, perform a method comprising:
defining an address space in a primary main array memory as a supernumerary overlay window, the primary main array memory being logically divided into multiple segments of contiguous memory locations;
relocating the supernumerary overlay window by redefining another address space which is located entirely within one of the multiple segments.

25. One or more media as recited in claim 24, wherein the relocating act occurs in response to a triggering event.

26. One or more media as recited in claim 24, wherein the relocating act occurs in response to a change in operating conditions of the computing device.

27. One or more media as recited in claim 24 further comprising:
intercepting an incoming memory access specifying an address of a memory location within the defined address space designated for the supernumerary overlay window;
redirecting the incoming memory access to a secondary supernumerary data resource, wherein the secondary supernumerary data resource is not within a full range of addressable memory locations of the primary main array memory

28. One or more media as recited in claim 24, wherein the defining act is characterized by storing a starting memory address of the defined address space for the supernumerary overlay window into a mode register of a memory system and the relocating act is characterized by storing another starting memory address of the redefined address space for the relocated supernumerary overlay window into the mode register of the memory system.

29. One or more media as recited in claim 24, wherein the secondary supernumerary data resource comprises non-array memory.
